(19) United States
(12) Patent Application Publication
(10) Pub. No.: US 2010/0231601 A1
(43) Pub. Date: Sep. 16, 2010

(54) Viewing Device Comprising an Electronic Means of Freezing the Display

(75) Inventors: Yves Sontag, Bordeaux (FR); Philippe Chabot, St. Aubine de Medoc (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/739,739

(22) PCT Filed: Oct. 23, 2008
(86) PCT No.: PCT/EP2008/064353

§ 371 Date: May 28, 2010

(30) Foreign Application Priority Data
Oct. 26, 2007 (FR) 07 07558

(51) Int. Cl. G09G 5/36; G09G 3/36

(52) U.S. Cl. 345/556; 345/87

(57) ABSTRACT

The present invention is a device making it possible to guard against the effects of resetting components sensitive to electromagnetic radiation forming an LCD display device. The device consists of a component (81) insensitive to radiation keeping in a memory (82) series of data supplied by the sensitive components and, when there is an incident, it supplies the last valid image to the LCD during the reset. The preferred field of application is that of viewing devices forming the cockpit of aircraft.

The field of the invention is that of viewing devices situated inside the flight deck of an aircraft. The invention relates to the viewing devices of which the electronic component for graphic generation or for display is sensitive to electromagnetic radiation.

An aircraft viewing device comprises a CPU/GPU (Central Processing Unit/Graphics Processing Unit) computing function more commonly called a Graphic Generation Unit. This function generates an image on the basis of input parameters carried on an external data bus which may be of the AFDX, Ethernet or CAN type for example and transmits a video stream to the display element. The display element is usually a liquid crystal (LCD) flat screen. The graphic generation function is generated by electronic components that are sensitive to electromagnetic radiation. They are usually electronic components of the FPGA (Field Programmable Gate Array) type with an SRAM (Static Random Access Memory) configuration cell. FPGAs have the advantage of allowing the implementation of complex functions and of being reprogrammable. They are volatile memory components, that is to say that their computer content is lost when they are not powered and therefore have to be initialized by a computer program each time they are started up. That is why they are accompanied by a FLASHROM (Flash Read Only Memory) memory, a nonvolatile memory, containing the program of configurations of the FPGA. When this type of component is subjected to electromagnetic radiation, it may be disrupted and this results in the loss or corruption of the image. In order to guard against this type of event, certain FPGAs incorporate a control device (CRC) which makes it possible to detect the corruption of their configuration memory. When the CRC detects such an event, the FPGA is reset in order to copy into the FPGA the computer program contained in the FLASHROM memory. This FPGA-resetting event is called an SEU (Single Event Upset). However, throughout the reconfiguration phase, the FPGA is no longer operational. The reconfiguration time lasts a few hundreds of milliseconds approximately and causes an effect that is perceptible by the user of the screen. The momentary loss of the image on a viewing device very seriously disrupts the pilot and has the effect, in most cases, of the equipment concerned being removed and replaced, even though this temporary image loss has no subsequent consequences. Paradoxically, it is possible to be in a situation in which the maintenance team carries out a replacement of the hardware when the viewing element is in perfect working order. In the case of an airline, this operation generates an unnecessary additional operating cost because of the unavailability of the airplane or because of the delay in the flight schedule.

Solutions exist that make it possible to guard against SEUs. Integrated-circuit components of ASIC (Application Specific Integrated Circuit) technology resolve this problem. They are integrated circuits etched into layers of silicon, commonly called “hardwired”. They are then insensitive to SEUs. In a network of viewing devices consisting of several graphic generation units, it would then be necessary for each graphic generation unit and display unit to be developed on an ASIC component. The development of an FPGA conversion to ASIC is actually very costly and a longer development time is involved than for an FPGA-based solution. These higher development costs arise because an ASIC solution requires the production of specific etching masks. Such a choice becomes profitable only for a sufficiently large volume. Moreover, an ASIC solution is not flexible as is the FPGA solution and therefore does not provide any possibility for the solution to be upgraded without major additional development cost.

There is an alternative that makes is possible to guard against the effect of SEUs. In the case of a modified LCD panel, the clocks of the power supply components of the lines and columns may be stopped. The liquid crystals then remain in their state thereby immobilizing the image during the electronic reconfiguration in question. The problem of this solution is that the frozen image is the last one displayed. When there is no loss of image but only corruption, the incident detection means requires a few tens of milliseconds to detect it, a sufficiently long time to display a corrupted image on the screen. This solution does not make it possible to retrieve an image prior to the detection of the incident and therefore freezes a false image. Moreover, it is necessary to modify the LCD panels. This operation causes problems in terms of mass production.

More precisely, the subject of the invention is a viewing device comprising a viewing device comprising, in succession and connected in series, a screen, a display unit and one or more graphic generation units connected to the display unit by means of a switch, the graphic generation units and the display unit having a means for detecting corruption or loss of the image, in that case initiating their reconfiguration, characterized in that the viewing device also comprises an electronic block and an associated memory, these two components recording in a loop, in nominal operation, a series of images of sufficient size so that it always comprises one valid image originating from one graphic generation unit, one valid image being an image formed before the detection of the failure by an alarm signal; when an incident is detected and is signaled to the electronic block, the electronic block transmits to the screen, for a period of reconfiguration of the electronic unit in question, the last valid image recorded in the memory.

The electronic components performing the display and graphic generation functions are usually FPGAs. During electromagnetic disturbances, they may be subject to SEUs and therefore potentially disrupt the display. The electronic block continually recording the images is insensitive to electromagnetic radiation; it is then said that the electronic component is masked. Therefore, in cases of electromagnetic radiation incidents, it is capable of presenting a valid image during the unavailability of the other graphic units; this is then called the temporary freezing of the image. An image may be considered to be unique or to be a composition of video windows. In any case, each of these entities is associated with a particular signature. The latter is transmitted to the screen by the digital video link if the window originates from an upstream case. A valid image is detected on the basis of its signature and of the incident detection means. The invention therefore consists in presenting on the screen in a temporary and controlled manner the totality or the portion concerned of the image seen by the pilot. The image series that is continuously recorded in a loop is approximately ten images. This quantity of images is sufficient to be able to retrieve an image prior to the detection of the incident. The processing time of the incident detection means is of the order of approximately ten milliseconds. The duration of freezing of the image is sufficiently short for the unique freezing effect to be tolerable and even imperceptible to the observer. Clearly, the function freezing the image on the screen is protected against the risk of a fixed image with one of the techniques known to those skilled in the art. If the problem persists, a real failure arises and the image or the relevant portion thereof is then no longer displayed.

If necessary, the hardware resource may also be used to carry out image capture. Specifically, the device optionally comprises command means that make it possible to record a displayed image in the electronic block and then transmit it to a digital output. The pilot then has a means of screen capture and of transferring the image to another screen. For example, it can specifically be envisaged that the pilot might need to show an image to another person on the flight deck. All he then has to do is to initiate a command to carry out the operation.

The invention is a solution involving less development cost in order to guard against the effects of SEUs over the whole chain generating the image. Only the additional electronic resources forming the invention are masked. In the case of multiple instrument panels, the invention prevents masking all of the display and graphic generation units. Keeping an FPGA-based and not ASIC-based configuration makes it possible to retain the advantages of flexibility and low-cost development of the FPGA architecture. Moreover, the additional elements can be positioned anywhere on the image-generation chain. The invention is suited to an architecture in which the graphic generation unit forms part of an electronic circuit board upstream of that of the display unit and to an architecture in which the graphic generation unit is integrated into the electronic circuit board of the display unit.

The invention will be better understood and other advantages will become apparent on reading the following description given in a non-limiting manner and with reference to the appended figures, among which:

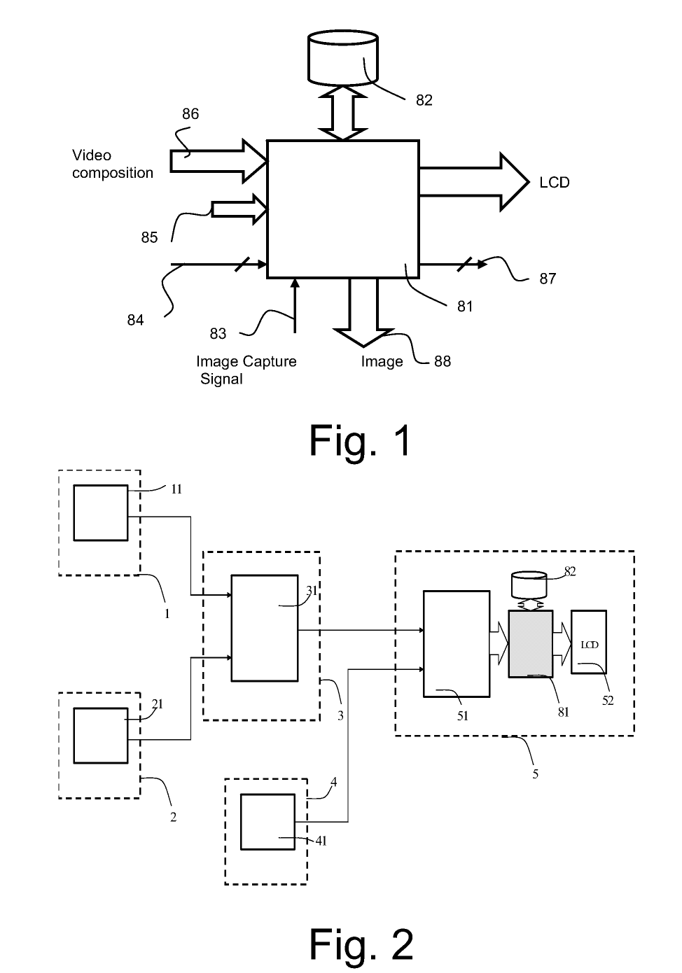

FIG. 1 represents the isolated electronic block according to the invention.

FIG. 2 represents an image generation chain for a viewing device comprising the device according to the invention located between the LCD and the display unit.

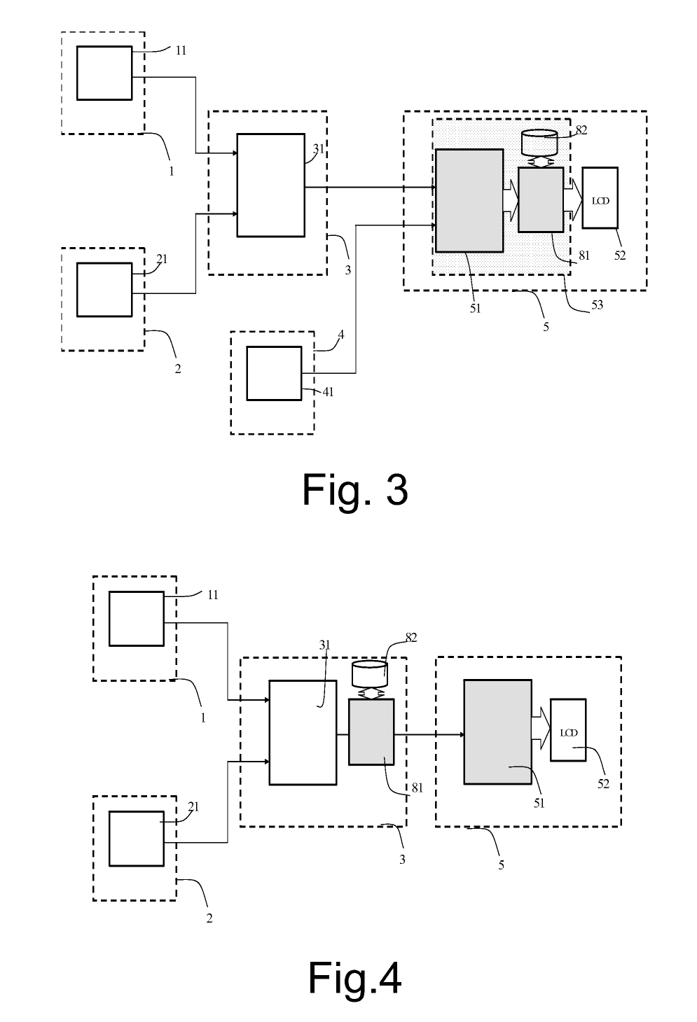

FIG. 3 represents an image-generation chain for a viewing device comprising a device according to the invention integrated into the display unit.

FIG. 4 represents an image-generation chain for a viewing device comprising the device according to the invention located in a case upstream of the display unit.

FIG. 1 represents the basic electronic block 81 constituting the invention. The electronic component is chosen so that it is insensitive to radiation and so that it can respond to the performance levels required by the graphic generation chain in terms of bandwidth. The component 81 is made insensitive to radiation because of its ASIC technology design. The desired logic functions are produced in silicon integrated circuits. An input/output bus is connected to a memory 82 of the DDR2 (Dual Data Rate) type. This memory has a sufficient bandwidth and memory space to continuously record series of approximately ten images. The block 81 is connected in series between the LCD and the sources of graphic generation. It must be positioned, in the graphic generation chain, behind the radiation-sensitive components. The electronic block 81 has a video input bus 86 connected to the graphic generation units and a video output bus connected to a viewing screen, usually of the LCD type. The video bus 85 contains the information necessary for the coordination of the graphic windows forming the image and the signatures associated with the various graphic windows. The input signal 84 is an alarm connected to the incident detection means and the signal 87 is a report output. The block 81 performs the functions of image recording, of permanent image control, of coordination of the graphic windows and of presentation of the last valid image. Optionally, it can be envisaged that the invention can also be used as an instantaneous image-capture function because all the operations necessary to this function are performed by the invention. A command signal 83 and an image output 88 are present as the function requires.

As a non-limiting example, the image generation chain of FIG. 2 comprises a flat screen 52 of the LCD type and a display unit 51. The electronic block 81 according to the invention and the memory 82 are connected in series between the LCD and the display unit. This set of components constitutes the display function of the viewing device. Upstream, the graphic generation units 1, 2 and 4 are connected. These graphic generation functions are performed on the basis of FPGA electronic components 11, 21 and 41. In this configuration comprising several graphic generation units, a video switch 3 based on an FPGA 31 makes it possible to connect the various video sources to the display unit. The display unit is directly connected to the graphic generation unit 4 and to the switch 3 which is connected to the graphic generation units 1 and 2. This graphic generation chain consists only of FPGAs and is therefore sensitive to electromagnetic radiation. This architecture has the advantage of having low development costs and allowing possible upgrading of the functions performed by the FPGAs but has the drawback of also being more costly to produce than an ASIC-based solution. Because this chain comprises only FPGAs, the electronic block 81 must be positioned at the end of the chain just before the LCD screen. This configuration makes it possible to have to mask only the component 81.

In a second embodiment according to FIG. 3, for reasons of recurrent production costs, the display unit 51 is a masked electronic component having the resources necessary to the embodiment of the invention. To an extent, the electronic block 81 and the memory 82 are already integrated into the display unit. In this choice of configuration, the development of the display function will integrate the function of the electronic block 81 and will therefore no longer become an additional electronic component. These two functions are merged inside one and the same ASIC component 53.

In a third embodiment according to FIG. 4, the electronic block 81 and the memory are connected in series between the switch and the display unit and located on an electronic circuit board separate from the screen. The electronic block 81 is an ASIC and the memory is of the DDR type. This configuration is suitable for an architecture in which the viewing devices comprise no graphic generation. The display unit is also masked and therefore insensitive to electromagnetic radiation. The image-freezing function can then be located upstream of the bus through which all the videos pass, that is to say at the output of the switch.

1. A viewing device comprising, in succession and connected in series, a screen, a display unit and one or more graphic generation units connected to the display unit by means of a switch, the graphic generation units and the display unit having a means for detecting corruption or loss of the image, in that case initiating their reconfiguration, wherein the viewing device also comprises an electronic block and an associated memory, these two components recording in a loop, in nominal operation, a series of images of approximately ten images so that it comprises one valid image originating from one graphic generation unit, one valid image being an image formed before the detection of the failure by an alarm signal, and when an incident is detected and is signaled to the electronic block, the electronic block transmits to the screen, for a period of reconfiguration of the electronic unit in question, the last valid image recorded in the memory, the duration of display of the last valid image being sufficiently short for the image-freezing effect to be imperceptible.

2. The viewing device as claimed in claim 1, further comprising failure detection means causing the display of a fixed image and in that, when a failure is detected, the image is no longer displayed.

3. The viewing device as claimed in 2, wherein the electronic block is an ASIC.

4. The viewing device as claimed in claim 3, wherein the electronic block and the memory are connected in series between the LCD and the display unit.

5. The viewing device as claimed in claim 3, wherein the electronic block and the memory are connected in series between the switch and the display unit.

6. The viewing device as claimed in claim 2, wherein the display unit is an ASIC, the electronic block and the memory are then integrated into the display unit.

7. The viewing device as claimed in claim 4, further comprising command means making it possible to record a displayed image in the electronic block and to then transmit it to a digital output.

8. The viewing device as claimed in claim 4, wherein the memory is a volatile memory of the double data rate type.
